(19) United States
(12) Patent Application Publication
(10) Pub. No.: US 2013/0100099 A1
(43) Pub. Date: Apr. 25, 2013

(54) ADAPTIVE LINE TIME TO INCREASE FRAME RATE

(71) Applicants: Nao S. Chuei, San Mateo, CA (US); Mark M. Todorovich, San Diego, CA (US); Koorosh Aflatooni, Cupertino, CA (US); Hemang Shah, San Diego, CA (US)

(72) Inventors: Nao S. Chuei, San Mateo, CA (US); Mark M. Todorovich, San Diego, CA (US); Koorosh Aflatooni, Cupertino, CA (US); Hemang Shah, San Diego, CA (US)

(73) Assignee: QUALCOMM MEMS Technologies, Inc., San Diego, CA (US)

(21) Appl. No.: 13/485,708

(22) Filed: May 31, 2012

Related U.S. Application Data
(60) Provisional application No. 61/550,223, filed on Oct. 21, 2011.

(51) Int. Cl. G06F 3/038

(52) U.S. Cl. 345/208; 345/204

(57) ABSTRACT

This disclosure provides systems, methods and apparatus, including computer programs encoded on computer storage media, for determining a line time for writing data to display elements on one or more common lines of an array of display elements. In one aspect, the line time is determined for writing data to a line of display elements based on the received image data to be written to the line of display elements.

This disclosure claims priority to U.S. Provisional Patent Application No. 61/550,223, filed Oct. 21, 2011, entitled “SYSTEMS AND METHODS FOR CHOOSING DISPLAY MODES,” and assigned to the assignee hereof. The disclosure of the prior application is considered part of, and is incorporated by reference in, this disclosure.

### TECHNICAL FIELD

This disclosure relates to methods and systems for write waveform timing in writing data to an electromechanical display.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Interferometric modulators can be driven by array driver circuits which write data to lines of display elements. Generally, a refresh rate of a display, for example a passive matrix display, is related to the write waveform line time for writing data to each line of the display. An increase in write waveform line time reduces the speed at which images may be updated. Thus, reduction in the line time required to write data to the display is desirable.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus for driving a display including a plurality of common lines and a plurality of segment lines connected to an array of display elements. The apparatus includes a controller configured to receive, as part of a frame of image data to be written to the array of display elements, image data for one or more common lines of the array, wherein the controller is configured to determine a line time for writing at least some of the image data to display elements along at least a first one of the one or more common lines of the array, wherein the determining is based at least in part on one or both of the write actuation state to be produced in the display elements along the at least a first one of the one or more common lines as defined by the at least some of the image data, and characteristics of at least some of the segment line transitions that will occur to place the segment lines in a series of states operable to write the image data to the one or more common lines. The apparatus also includes a common driver and a segment driver configured to drive the array of display elements to write the at least some of the image data to display elements along the at least one of the one or more common lines with the determined line time.

Another innovative aspect of the subject matter described in this disclosure can be implemented in a method for driving a display including a plurality of common lines and a plurality of segment lines connected to an array of display elements. The method includes receiving image data, including image data for one or more common lines, determining a line time for writing the image data to one or more common lines based at least in part on one or both of a write actuation state of display elements along one or more common lines, and characteristics of at least some segment line transitions in writing the image data to the display elements along the one or more common lines. The method also includes writing the image data to display elements along one or more common lines with the determined line time.

Another innovative aspect of the subject matter described in this disclosure can be implemented in an apparatus for driving a display including a plurality of common lines and a plurality of segment lines connected to an array of display elements. The apparatus includes means for receiving image data, including image data for one or more common lines, means for determining a line time for writing the image data to one or more common lines based at least in part on one or both of a write actuation state of display elements along one or more common lines, and characteristics of at least some segment line transitions in writing the image data to the display elements along the one or more common lines. The apparatus also includes means for writing the image data to display elements along one or more common lines with the determined line time.

Another innovative aspect of the subject matter described in this disclosure can be implemented in a computer program product for processing data for a program configured to drive a display including a plurality of common lines and a plurality of segment lines connected to an array of display elements. The computer program product includes a non-transitory computer-readable medium having stored thereon code for causing processing circuitry to receive image data including image data for one or more common lines, determine a line time for the one or more common lines based at least in part on one or both of a write actuation state of display elements along one or more common lines and characteristics of at least some segment line transitions in writing the image data to the display elements along the one or more common lines, and write the image data to display elements along one or more common lines with the determined line time.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a timing diagram for common and segment signals that may be used to write the frame of display data.

FIG. 10A is an example waveform of staggered segment transitions that may be used in some implementations.

FIG. 10B is an example waveform of segment transitions including a pre-discharge waveform that may be used in some implementations.

FIG. 11 is a flowchart of a method of writing data to a display according to some implementations.

FIG. 12 is a flowchart of another example method of writing data to a display according to some implementations.

FIGS. 13A and 13B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Particular implementations of the subject matter described herein include a variable write waveform line time for different lines of display elements in a display. In some aspects, the line time is variable based on the image data that is to be written the display elements. For example, the line time of a particular line of display element may be a function of the number of display elements that will transition from an un-actuated state to an actuated state and the number of segment line transitions for writing the image data to the display.

Particular implementations of the subject matter described in this disclosure can be implemented to realize one or more of the following potential advantages. The time required to write display data may be reduced when compared to drivers known in the art. This may increase the frame rate at which images are displayed, and reduce artifacts associated with lower frame rate. Further, the performance of display elements may be improved with the same overall update rate for the display. For a given target update rate, it can be useful to allocate line time duration differently for different lines of the display based on particular image data to be written to the display and the particular structure of the display elements along the line. This can provide more margin for suitable operation for the display elements, and as a result, the yield of the display panels can be improved without reducing frame rate or sacrificing image quality.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

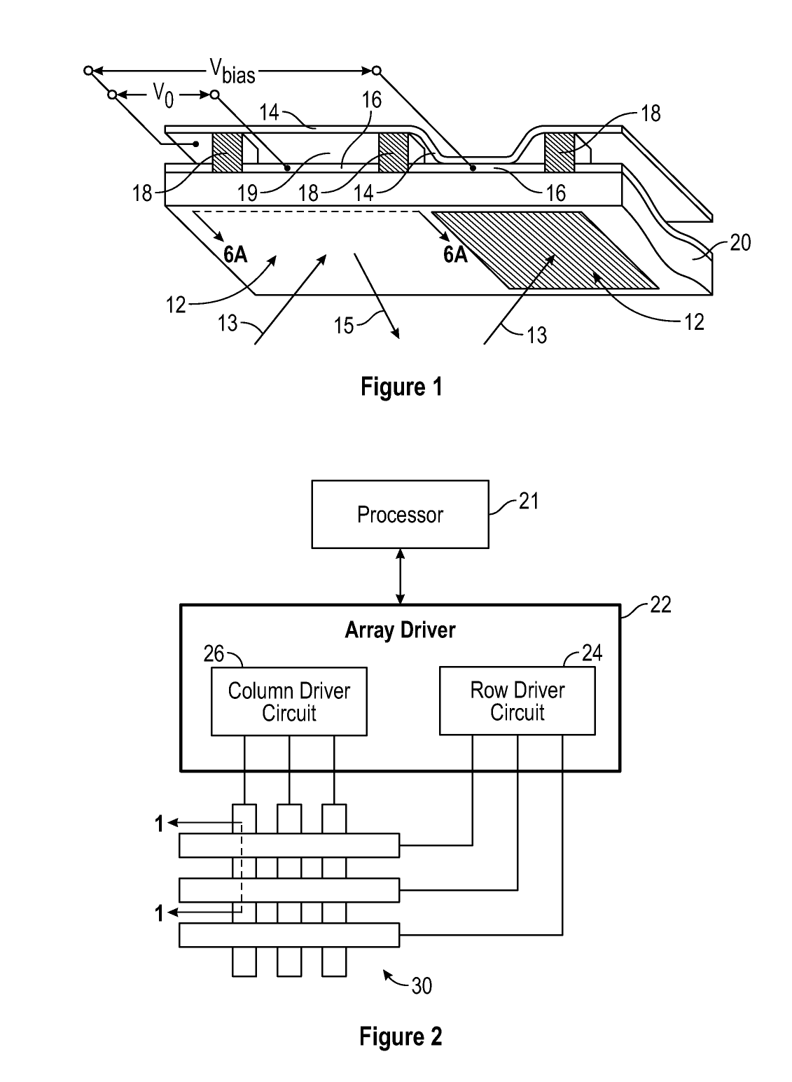

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

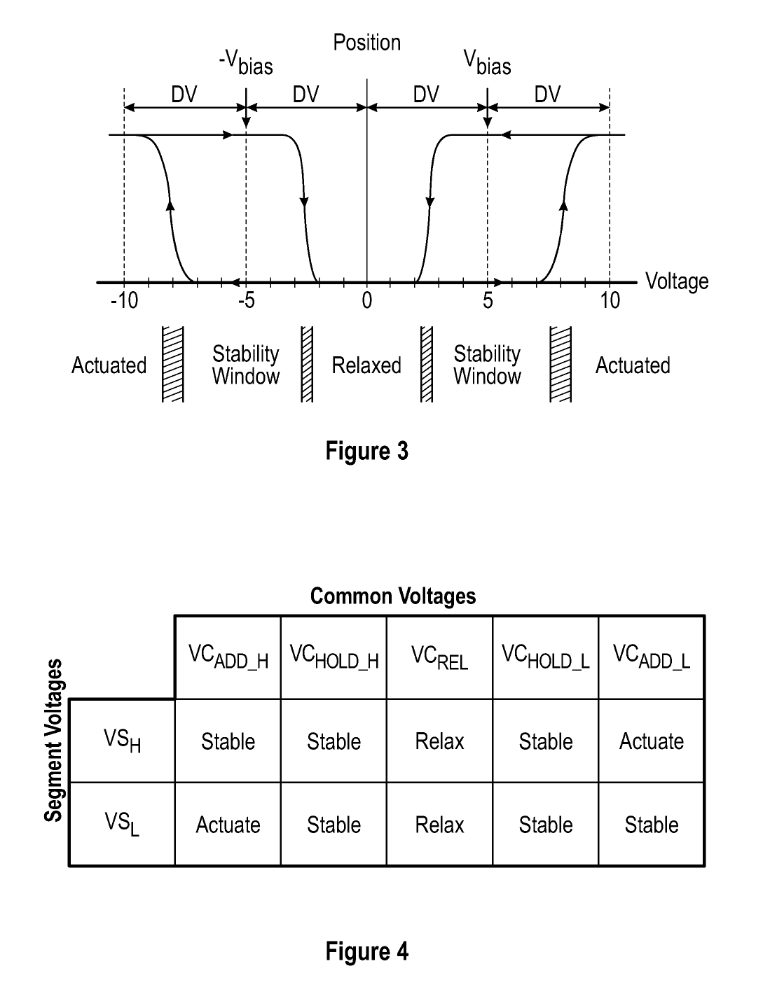

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

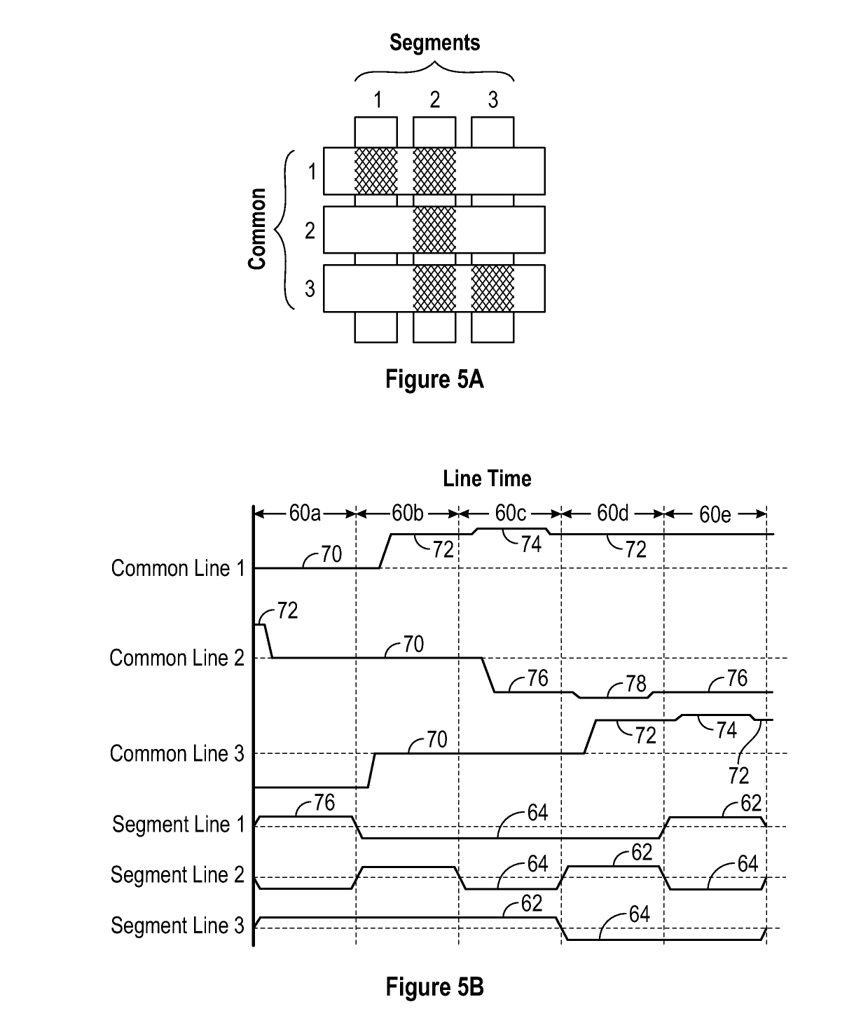

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

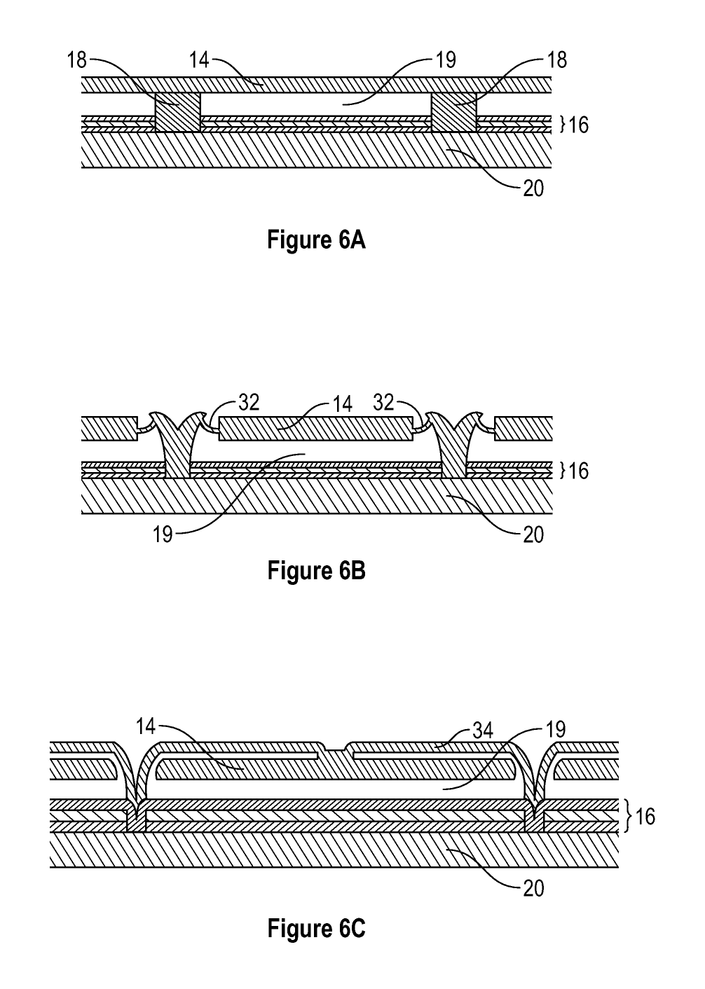

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

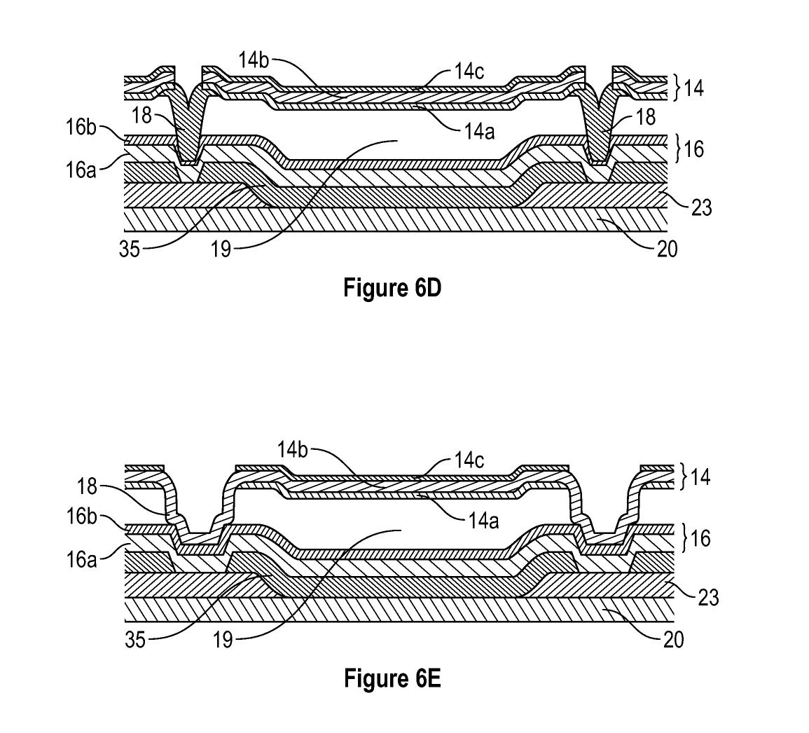

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

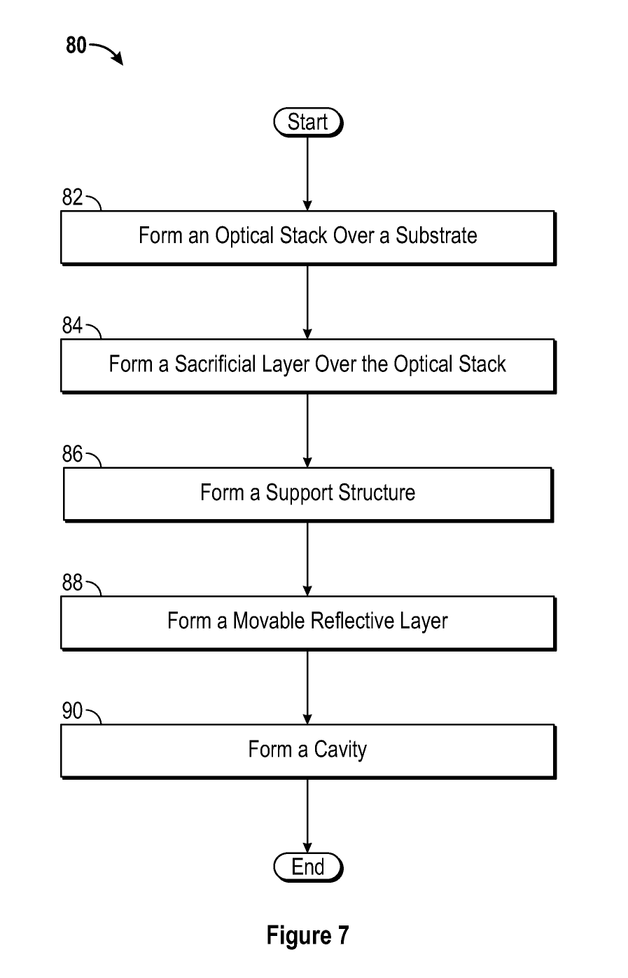

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

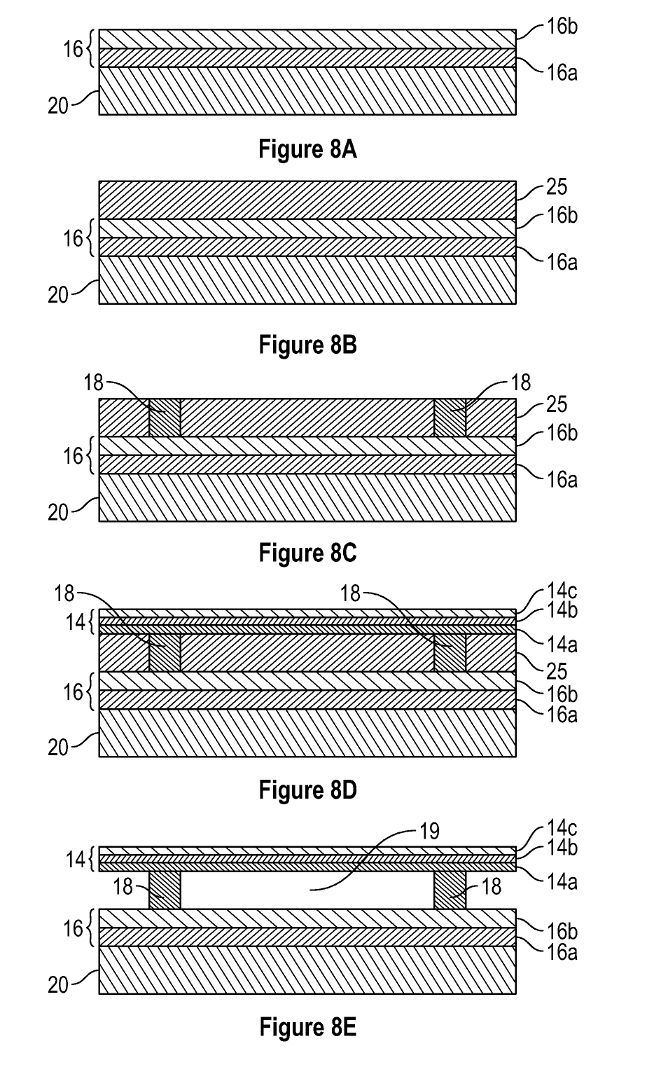

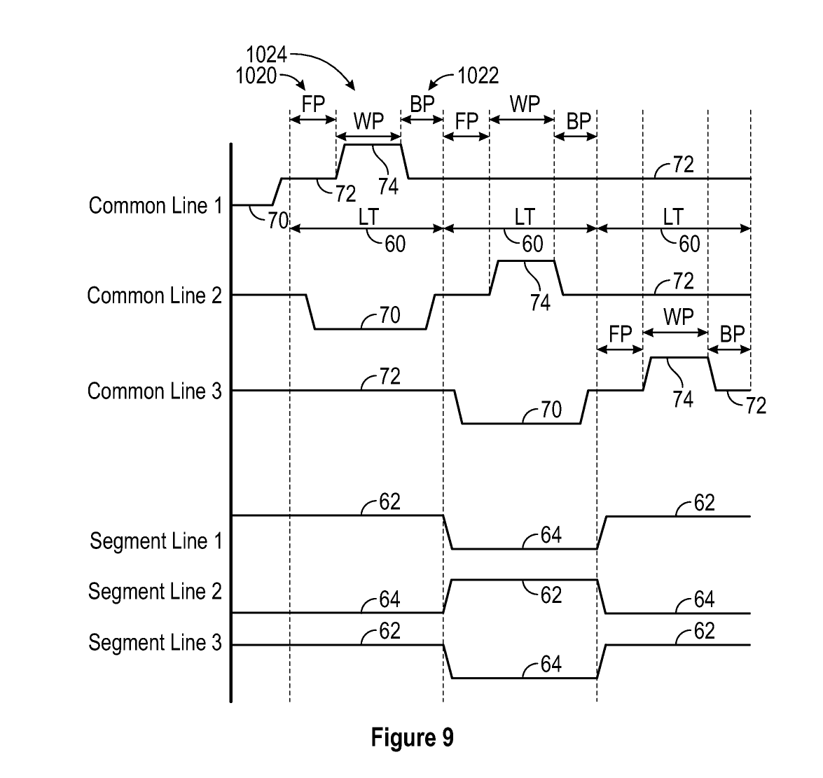

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

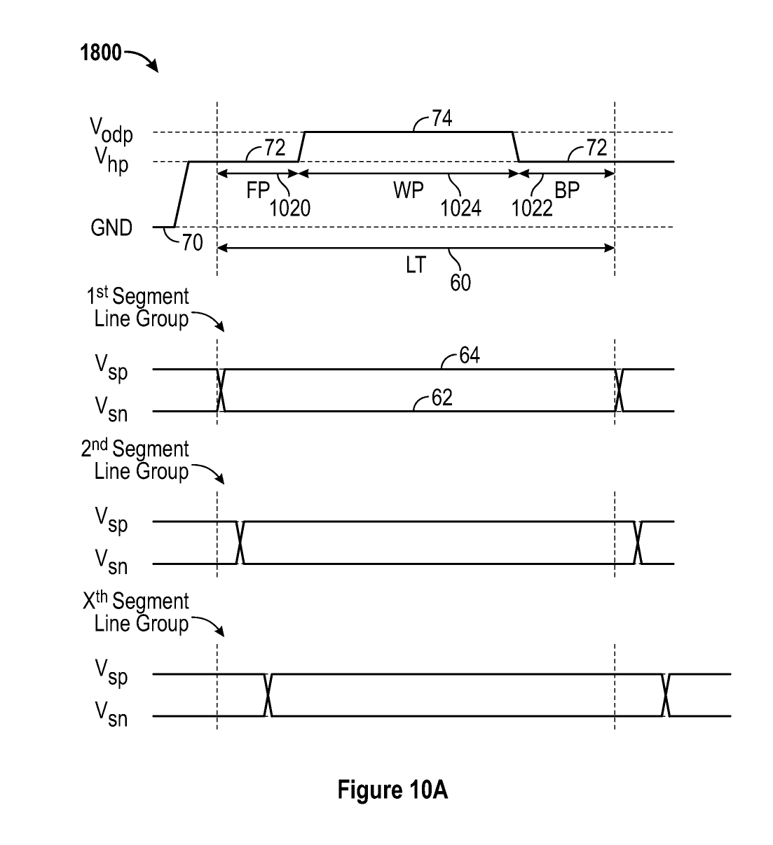

As discussed above with reference to FIGS. 5A and 5B, data may be written to a display through variation of a common line driving signal and a segment line driving signal. FIG. 9 shows an example of a timing diagram for common line and segment line driving signals that may be used to write display data. FIG. 9 includes three positive common line write waveforms (Common Line 1, Common Line 2, and Common Line 3). Also illustrated are three segment line waveforms (Segment Line 1, Segment Line 2, and Segment Line 3). A person having ordinary skill in the art will recognize that the number of common lines and segment lines configured to drive the array of display elements is based on the type of display, and/or the driving scheme used for driving the display.

As illustrated in FIG. 9, each display element in the array may initially be driven to a non-actuated state by application of a clearing pulse having a release voltage 70. Following the clearing pulse, a common line may be transitioned to a hold voltage level, for example a high hold voltage 72 as illustrated in FIG. 9. To write data to a line of display elements, the common line is transitioned from the high hold voltage 72 to a high address voltage 74 and back to the high hold voltage 72. There are three time periods during the process to write data, as illustrated in FIG. 9, which may collectively be referred to as a line time 60.

A line time 60 includes a front porch 1020, a write pulse 1024, and a back porch 1022. A front porch 1020 may be defined as a delay time following initiation of segment line transitions and before the write pulse 1024 in order to avoid error in writing data to a display element along the common line. During a write pulse 1024, a voltage level corresponding to an address voltage, for example a high address voltage 74, is applied as illustrated in FIG. 9. A back porch 1022 may be defined as a delay time following the write pulse 1024 and prior to initiation of segment line transitions in order to avoid error in writing data to a display element connected to the common line. The front porch 1020 and back porch 1022 may compensate for a delay during a transition between an address voltage, such as high address voltage 74, and a hold voltage, such as high hold voltage 72.

As described above with reference to FIG. 5B, the segment transitions include a low segment voltage 64 and a high segment voltage 62 such that, for a positive polarity write waveform, the display element is actuated when a write pulse 1024 of a high address voltage 74 is applied and the corresponding segment line is at a low segment voltage 64. The front porch 1020 and back porch 1022 may be provided to introduce delays between the segment transitions and the edges of the write pulse. The delays may be useful because of waveform distortions of the common line potentials during segment transitions due to capacitance coupling of the components of the circuit, or the like.

In the example illustrated in FIG. 9, a positive polarity is assumed for driving the display such that the front porch 1020 and back porch 1022 correspond to a high hold voltage 72 and the write pulse 1024 corresponds to a high address voltage 74. As shown in FIG. 5B, the waveform may also have a negative polarity. For a negative polarity waveform, a front porch 1020 and back porch 1022 correspond to a low hold voltage 76, and the write pulse 1024 corresponds to a low address voltage 78 (as shown in FIG. 5B).

Table 1 below shows examples of a front porch 1020 duration, a write pulse 1024 duration, and a back porch 1022 duration corresponding to different frame rates in one implementation for driving a display having 1,152 common lines.

TABLE 1
Example Frame Rates and Timing

| Frame | Front | Write | Back | Total Line |
|---|---|---|---|---|
| Rate | Porch (μs) | Pulse (μs) | Porch (μs) | Time (μs) |
| 15 Hz | 8 | 40 | 8 | 56 |
| 6.7 Hz | 12 | 70 | 47 | 129 |

As shown in Table 1, for a frame rate of 15 Hz, a front porch 1020 may be set to 8 μs, a write pulse 1024 may be set to 40 and a back porch 1022 may be set to 8 μs for a total line time 60 of 56 μs. Alternatively, for a frame rate of 6.7 Hz, a front porch 1020 may be set to 12 μs, a write pulse 1024 may be set to 70 μs and a back porch 1022 may be set to 47 μs for a total line time 60 of 129 μs.

A front porch 1020 may be set to provide sufficient time for all segment lines to settle to their new state following a segment line transition and prior to the application of the write pulse 1024. Similarly, a back porch 1022 may be provided such that a write pulse 1024 may settle to a hold state prior to a subsequent segment line transition. The duration of the write pulse 1024 provides sufficient time to enable actuation of the display element on segment lines which are to be actuated by the write pulse 1024.

For example, in driving an array of display elements having a plurality of common lines and a plurality of intersecting segment lines connected to the display elements, the segment line transitions along a common line in the array may be staggered to reduce cross-talk in writing data to the display. Cross-talk may occur when a large number of segment lines are transitioned in phase at the start of a new line time. When segments are switching from −Vs to +Vs (or from +Vs to −Vs) due to the fact that the segment lines are being switched to write data to a new line, which in general is different data than that written to the previous line, a sudden change in the amount of charge on the segment lines is produced. This may cause a voltage transient on the common lines, leading to a potentially undesirable voltage levels along one or more common electrodes. As a result, display elements that were previously actuated may be released in error due to the cross talk of the transitioning segment lines.

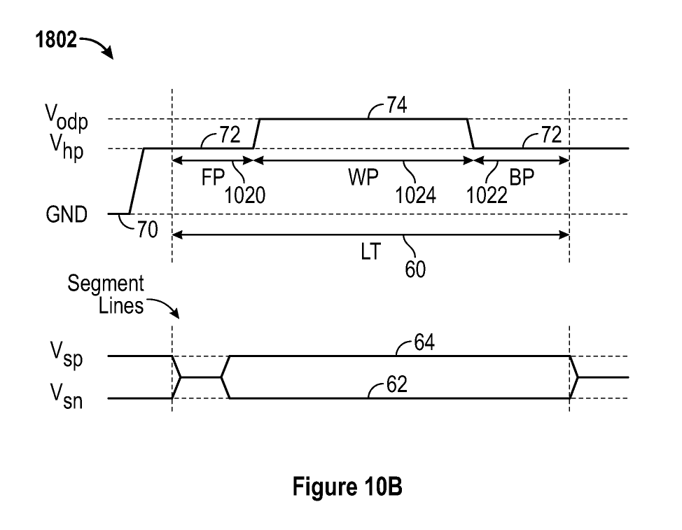

FIG. 10A is an example waveform 1800 with staggered segment line transitions that may be used in some implementations to reduce this problem. The segment transitions are staggered from the start of the line time 60. As shown in FIG. 10A, the segment lines are grouped into first through third segment line groups. Within each group, segment lines are configured to transition in phase with each other. Each group of segment lines is configured to transition out of phase with the other groups of segment lines (for example, delayed from the previous group as shown in FIG. 10A). This can be useful for some images where there are many segment transitions from one line to the next, which causes some cross-talk between the segment electrodes and the common electrode. The stagger reduces the cross-talk and reduces the effect the segment transitions have on the common line waveform. As shown in FIG. 10A, the duration of the front porch 1020 may be set to provide sufficient time for all staggered segment line groups to transition prior to a write pulse 1024. Although FIG. 10A shows three stagger groups, in one implementation, there are a total of 3072 segment lines, and they are grouped into eight stagger groups of 384 segment lines in each group. There is about one microsecond delay between the transitions of each group, producing the 8 microsecond front porch of Table 1 above. In this implementation, no more than 384 segment lines should transition at the same time, which has been found to produce acceptably small voltage transients on the common lines.

In some implementations, to reduce crosstalk, a pre-discharge segment waveform may be used. FIG. 10B is an example waveform 1802 of segment transitions including a pre-discharge waveform that may be used in some implementations. For a pre-discharge segment waveform as shown in FIG. 10B, segments switching between +Vs and −Vs may go to ground for a short duration (for example, +Vs to ground for a short duration, and then to −Vs). Such a pre-discharge waveform can be used to spread out the charge injection due to segment transitions over a longer period, thereby reducing the interference of the segment line transitions with the common line waveform. Furthermore, a pre-discharge waveform can be useful by dumping some charge onto the ground line of the driver, where without the pre-discharge waveform, all of the charge would be dumped onto the Vsp or Vsn lines, requiring further power to drive the lines and would increase cross-talk. In this implementation, the duration of the front porch 1020 may be set to provide sufficient time for all segment lines to transition through the complete pre-discharge waveform.

The duration of the write pulse 1024 may be set to provide adequate charge to write all display elements connected to the common line. A display element in an actuated position exhibits higher capacitance than a display element in an un-actuated state. As discussed above with reference to FIG. 9, a clearing pulse 70 may be applied to a common line prior to writing image data to display elements along the common line. The clearing pulse 70 is configured to transition the display elements along the common line to an un-actuated or relaxed state prior to writing the image data. In writing the image data, a larger capacitance is connected to the drive lines when a first number of display element are transitioned from an un-actuated state to an actuated state compared to when a second number of display element are transitioned from un-actuated state to actuated if the second number of display element transitions is less than the first number of display element transitions. As a result, more charge must be sourced from the driver when more display elements are transitioned from an un-actuated state (for example, the state after the clear cycle 70) to an actuated state due to the larger capacitance. The duration of the write pulse 1024 according to a conventional technique is based on the assumption that potentially all display elements along a common line will be transitioned from an un-actuated state to an actuated state when writing a line of display elements.

The duration of the back porch may be selected to reduce or prevent accidental release of actuated display elements in a previously written line when the segments transition to the new data for the next line. This accidental release can occur if there is insufficient delay between the end of the write pulse for the previous line and the segment transitions that occur to write the immediately subsequent line. For example, with reference to FIG. 9, display elements along common line 1 may be accidentally released following the write pulse 74 if a segment line (for example, segment line 2) transitions very shortly after the write pulse 74 of common line 1. Since the display element corresponding to segment line 2 and common line 1 may not yet be fully mechanically stabilized to the actuated state immediately following the write pulse 74, the transition of the segment line 2 from the low segment voltage 64 to the high segment voltage 62 may cause the display element to accidentally release. Because the display elements are very sensitive to transient voltage swings immediately after being actuated, it has been found useful to maintain a period following the end of each write pulse 1024 where no segment transitions occur, not even the transitions of the first stagger group shown in FIG. 10A.

It may be further noted that the back porch is more important to proper display element operation for some common lines than for others in the display. In an array of display elements having a plurality of common lines intersecting a plurality of segment lines, different common lines are situated at different distances from the segment driver connected to the plurality of segment lines. As a result of the difference in distance from the segment driver, when the segment driver changes the state of a segment line, the transition is steepest at the common lines nearest the segment driver. Due to impedance along the segment line length, the rise time of the voltage is longer at the far end of the display away from the segment driver. As a result, the segment lines exhibit sharper and steeper transitions for display elements that are closer to the segment driver than for display elements that are farther from the segment driver. Due to the sharper transitions close to the segment driver, the segment line transitions produce larger transients on the common lines and may cause more accidental release of display elements that are closer to the segment driver that have transitioned to an actuated state relative to display elements that are farther from the segment driver. Therefore, a long back porch 1022 is more important for common lines that are closer to the segment driver, relative to common lines that are farther from the segment driver.

Conventionally, the same front porch 1020 duration, back porch 1022 duration, and write pulse duration 1024 are used for every common line across the array. In such implementations, the front porch 1020 used for every common line is the overall maximum front porch 1020 duration. Furthermore, the back porch 1022 duration used for every common line is the overall maximum back porch 1022 duration. In addition, the write pulse 1024 duration used is the overall maximum write pulse 1024 duration. The line time used for every common line in these conventional implementations is therefore max(FP)+max(WP)+max(BP).

As discussed above, the frame rate of the display is inversely proportional to the line time, such that as the line time increases, the frame rate decreases. Since the line time includes the combined time of a front porch 1020, back porch 1022, and write pulse 1024, a reduction in the front porch 1020, the back porch 1022, and/or the write pulse 1024 would result in a faster frame rate for the display.

According to some implementations, a line time duration (for example, sum of front porch 1020, back porch 1022, and/or write pulse 1024) may be adjusted based on data to be written to an array of display elements. Using this technique, display elements connected to common lines that can be written faster without errors due to the nature of the data being written are written faster, thus reducing the total time required to write a frame of data.

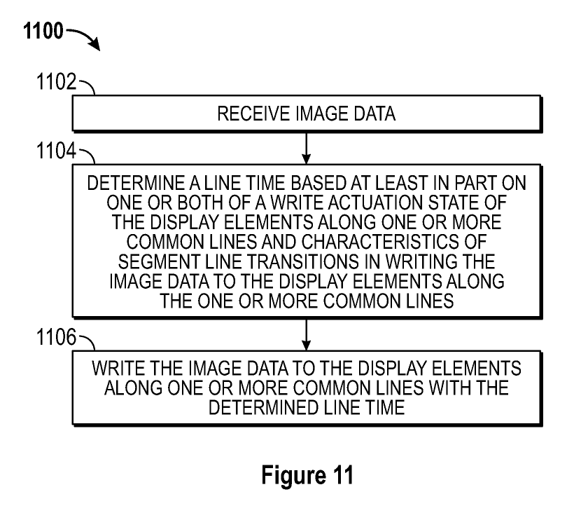

FIG. 11 is a flowchart of a method of writing data to display according to some implementations. The method 1100 includes receiving image data as shown in block 1102. At block 1104, a line time is determined based at least in part on one of a write actuation state of the display elements along one or more common lines and characteristics of segment line transitions in writing the image data to the display elements along the one or more common lines. For example, the front porch 1020 and back porch 1022 may be set based on the number of segment line transitions that are occurring in writing data to the display.

For the front porch setting, the number of stagger groups can be reduced based at least in part on the characteristics of the segment line transitions that will occur when the segments are switched from being set for writing the previous line to being set for writing the current line. For example, if a relatively small number of segment transitions are occurring, the number of stagger groups can be reduced. For example, if the implementation described above with reference to FIG. 10A is used, and if 650 of the 3072 segment lines are transitioning, the segment lines can be split into two groups, each containing 325 of the transitioning lines. Because there are two stagger groups rather than eight, the front porch can be reduced to close to one or two microseconds rather than the usual eight for writing this line. If no segment lines are switching (for example, if the same data is written to display elements along a common line and display elements along an immediately preceding common line), no front porch at all is necessary. In some implementations, the number of stagger groups can be determined based on a comparison of the number of segment line transitions in one direction relative to the number of segment line transitions in the opposite direction. For example, if the number of segment line transitions that occur from a positive polarity to a negative polarity and the number of segment line transitions that occur from a negative polarity to a positive polarity are substantially equal, the number of stagger groups can be reduced.

To set the back porch, the number of segment transitions that will occur when preparing the segment lines to write the next line are considered. If there are few transitions that will occur for the next line, or if the transitions are relatively evenly distributed between the two transition directions, the back porch can be shortened. If no segments will switch to write the next line (for example, if the same data is written to display elements along a common line and display elements along an immediately subsequent common line), the back porch can be eliminated entirely. The data corresponding to an image to be written to the display may be processed to determine the number of segment transitions that will occur in writing the data to the array.

Further, the number of display elements that will be transitioned from an un-actuated state to an actuated state may be determined based on the data to be written to the line of display elements. For example, as discussed above, display elements along a particular common line may first be transitioned to an un-actuated state using a clearing pulse 70. The data corresponding to the particular common line may be analyzed to determine the number of display elements that will be transitioned to an actuated position when the data is written to the line of display elements. The fewer display elements that are going to be actuated during the write cycle, the shorter the write pulse 1024 can be. If all the display elements are going to remain un-actuated, then no write pulse at all is required, since the clear cycle has already set the display elements in the desired state for that line.

At block 1106, the image data is written to the display elements using the determined line time along one or more common lines. In some implementations, a line time may be determined for display elements along a particular common line, and the data may be written to the display elements along the particular common line using the determined line time. In some implementations, a line time may be determined for display elements along a first common line and the determined line time may be used to write data to display elements along a second common line. For example, a line time having the longest duration among a group of common lines may be used to write data to each common line in the group of common lines. In some implementations, an average value of determined line times for a group of common lines may be used to write data to the display elements along the common lines of the same group.

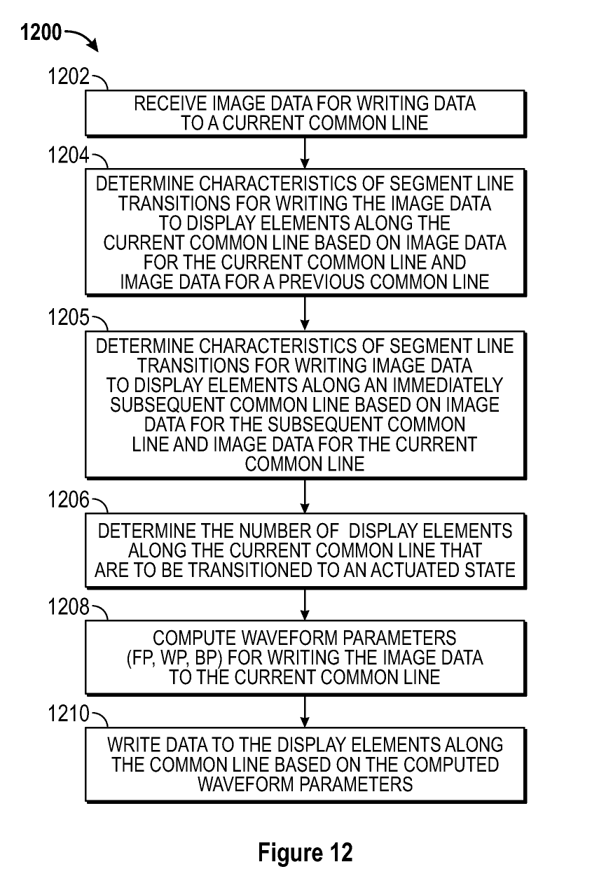

FIG. 12 is a flowchart of another method of writing data to display according to some implementations. The method 1200 includes receiving image data for writing data to a current common line as shown in block 1202. The common line is connected to a line of display elements in an array of display elements. At block 1204, characteristics of segment line transitions for writing the image data to display elements along the current common line may be determined based on image data for the current common line and image data for a previous common line. For example, in some implementations, for a sequential data write operation, the number of segment lines that will be transitioned is based on the data that was written to a previous line of display elements relative to the data to be written to a current line of display elements. For the first line of a frame of data, the previous line may be the last line written for the previous frame. Further, the number of segment line transitions may also be based on the polarity of the common line waveform applied to the previous line of display elements and the polarity of the common line waveform applied to the current line of display elements for writing image data. For example, in writing identical data sequentially to display elements along a first common line and display elements along a second common line, the polarity of the common line waveform will determine if any of the segment lines will be transitioned. That is, if the waveform applied to the first common line has opposite polarity to the waveform applied to the second common line, the segment lines corresponding to display elements along the second common line that are to be actuated will be transitioned to write the image data to the display elements along the second common line. In some implementations, the front porch 1020 and the back porch 1022 may be set based on the amount of stagger corresponding to the actual number of segment lines that are transitioned in phase, rather than the longest possible stagger time in writing data to the display as described above with reference to FIG. 11.

At block 1205, the characteristics of segment line transitions are determined for writing image data to display elements along an immediately subsequent common line based on image data for the subsequent common line and image data for the current common line. For example, the number of segment line transitions for a subsequent line of display elements may impact display elements which have been transitioned to an actuated state in a current line of display elements. Therefore, according to some implementations, the back porch 1022 may be determined based at least in part on the number of segment lines that will be transitioned for writing image data to the subsequent common line in order to provide sufficient time for the display elements along the current line to mechanically stabilize prior to the transitions of the segment lines for writing data to the subsequent line. At block 1206, the number of display elements along the current common line that are to be transitioned to an actuated state is determined. According to an example, the write pulse 1024 duration may be set based at least in part on the number of display elements that will transition from an un-actuated to an actuated state based on display data to be written to the current common line. As discussed above, the write pulse 1024 duration may be set based on the number of transitioning display elements, and the resulting capacitance change and charge leakage along the common line.

At block 1208, the waveform parameters, including one or more of the front porch 1020 duration, the back porch 1022 duration, and the write pulse 1024 duration for writing the image data to the current common line are calculated based at least in part on the determinations of one or more of blocks 1204, 1205, and 1206. At block 1210, the data is written to the display elements along the current common line based on the computed waveform parameters.

As discussed above, a line time for writing image data to a common line connected to a line of display elements may be determined based on the image data to be written to the display elements. In some implementations, the image data is analyzed to determine the number of display elements that will be transitioned from an un-actuated to an actuated state, and the number of segment line transitions that will occur. In some implementations, other factors, such as the color of display elements, and the location of a common line in the array may also be used to determine the line times.

For example, since display elements which exhibit different colors have different characteristics, they may have different response times to the application of write pulse 1024 and require different minimum write pulse 1024 durations. Similarly, a suitable front porch 1020 and back porch 1022 for different color display elements may be dependent on the color of the display element. In some implementations, different color display element rows are driven with driving signals corresponding to different write waveform line times. The line times of each color display element row may be configured based on the characteristics of the specific color, and the corresponding physical structure and response time of the particular color display element.

For example, a line time for lines having only blue display elements in the array may be less than a line time for green display elements in the array. A row including green display elements may be configured with a longer line time than a row with red display elements. Similarly, the row of red display elements may be configured to have a longer line time than the row of blue display elements.

Further, in some implementations the line times may also be determined based on a position of the line of display elements relative to a segment driver. For example, since the segment transitions occur sooner for common lines closer to the segment driver, in some implementations, the back porch 1022 duration may be set to be relatively longer for common lines closer to the segment driver.

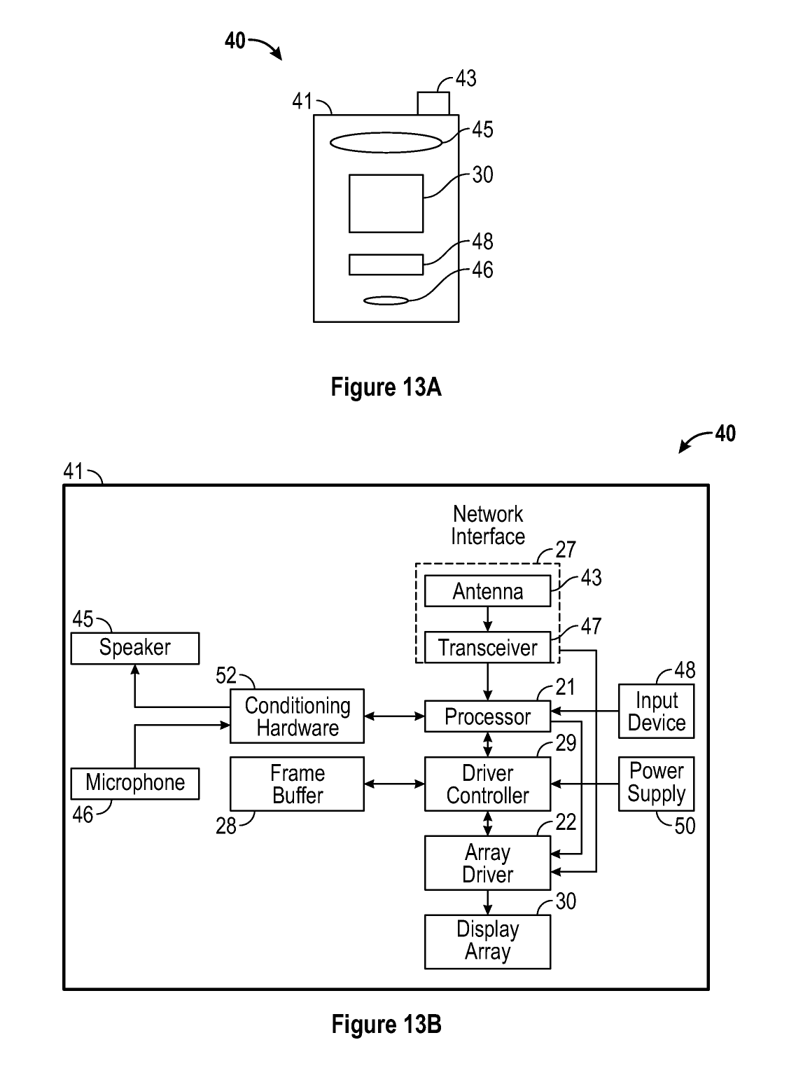

FIGS. 13A and 13B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 13B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level. The frame buffer 28 may be configured to store the processed image data corresponding to a previous write operation (for example, image data corresponding to one or more previous lines of display elements), for access by the processor 21. The processor 21 may be configured to retrieve the previous image data to determine a line time for writing current image data to a line of display elements.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Further, the drive controller 29 may be configured to determine the line time for writing the image data to a line of display elements as discussed above with reference to FIGS. 12 and 13. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22. Further, the drive controller 29 may include an associated memory (not shown) configured to store the formatted image data corresponding to a previous write operation (for example, image data corresponding to one or more previous lines of display elements), for access by the drive controller 29. The drive controller 29 may be configured to retrieve the previous formatted image data to determine a line time for writing current image data to a line of display elements.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for driving a display including a plurality of common lines and a plurality of segment lines connected to an array of display elements, the apparatus comprising:
a controller configured to receive, as part of a frame of image data to be written to the array of display elements, image data for one or more common lines of the array, wherein the controller is configured to determine a line time for writing at least some of the image data to display elements along at least a first one of the one or more common lines of the array, wherein the determining is based at least in part on one or both of
the write actuation state to be produced in the display elements along the at least a first one of the one or more common lines as defined by the at least some of the image data, and
characteristics of at least some of the segment line transitions that will occur to place the segment lines in a series of states operable to write the image data to the one or more common lines; and
a common driver and a segment driver configured to drive the array of display elements to write the at least some of the image data to display elements along the at least one of the one or more common lines with the determined line time.

2. The apparatus of claim 1, further comprising a memory configured to store image data for at least one previously written common line, and wherein the controller is configured to compare the image data with the image data for the at least one previously written common line, and wherein the controller is configured to determine the characteristics of segment line transitions that will occur to place the segment lines in a state operable to write the image data to the display elements along the at least one of the one or more common lines based at least in part on the image data comparison.

3. The apparatus of claim 1, further comprising a memory configured to store image data corresponding to an immediately subsequent line of display elements, and wherein the controller is configured to compare the image data for the at least one of the one or more common lines with the image data corresponding to the immediately subsequent line of display elements to at least partially determine the line time.

4. The apparatus of claim 2, wherein the controller is configured to compare the polarity of a waveform to be used when writing the image data to the polarity of the waveform used to write the at least one previously written common line, and wherein the controller is configured to at least partially determine the characteristics of segment line transitions that will occur to place the segment lines in a state operable to write the image data to the display elements along the at least one of the one or more common lines based at least in part on the polarity comparison.

5. The apparatus of claim 1, wherein the line time includes a front porch duration, a back porch duration, and a write pulse duration.

6. The apparatus of claim 5, wherein the controller is configured to determine at least one of the front porch duration and the back porch duration based at least in part on the characteristics of at least some of the segment line transitions.

7. The apparatus of claim 5, wherein the controller is configured to determine the write pulse duration based at least in part on a number display elements on the at least a first one of the one or more common lines that are to be transitioned from an un-actuated state to an actuated state when writing the received image data.

8. The apparatus of claim 7, wherein the common driver is configured to apply a clearing pulse to the at least a first one of the one or more common lines to transition the display elements along the at least a first one of the one or more common lines to the un-actuated state.

9. The apparatus of claim 1, wherein the controller is configured to determine the line time based at least in part on the color of the display elements.

10. The apparatus of claim 1, wherein the controller is configured to determine the line time based at least in part on a segment line transition edge sharpness.

11. The apparatus of claim 1, wherein the controller is configured to determine a first line time for writing data to display elements along a first common line, and wherein the segment driver and common driver are configured to write data to display elements along the first common line using the first line time, and wherein the controller is configured to determine a second line time that is different than the first line time for writing data to display elements along a second common line, and wherein the segment driver and common driver are configured to write data to display elements along the second common line using the second line time.

12. The apparatus of claim 1, further comprising:
a processor that is configured to communicate with the display, the processor being configured to process image data; and
a memory device that is configured to communicate with the processor.

13. The apparatus as recited in claim 12, further comprising:
an image source module configured to send the image data to the processor.

14. The apparatus as recited in claim 13, wherein the image source module includes at least one of a receiver, transceiver, and transmitter.

15. The apparatus as recited in claim 12, further comprising:
an input device configured to receive input data and to communicate the input data to the processor.

16. The apparatus of claim 1, wherein the controller is configured to determine the line time for writing current image data to display elements along the one or more common lines of the array based on the write actuation state of the display elements along the one or more common lines.

17. The apparatus of claim 1, wherein the controller is configured to determine the line time for writing current image data to display elements along the one or more common lines of the array based on characteristics of segment line transitions for writing the current image data to the display elements along the one or more common lines.

18. The apparatus of claim 1, wherein the controller is configured to determine the line time for writing current image data to display elements along the one or more common lines of the array based on the write actuation state of the display elements along the one or more common lines and based on characteristics of segment line transitions for writing the current image data to the display elements along the one or more common lines.

19. A method for driving a display including a plurality of common lines and a plurality of segment lines connected to an array of display elements, the method comprising:
receiving image data, including image data for one or more common lines;
determining a line time for writing the image data to one or more common lines based at least in part on one or both of
a write actuation state of display elements along one or more common lines, and
characteristics of at least some segment line transitions in writing the image data to the display elements along the one or more common lines; and
writing the image data to display elements along one or more common lines with the determined line time.

20. The method of claim 19, further comprising storing previously received image data, and comparing the received image data with the previously received image data to at least partially determine the line time.

21. The method of claim 19, further comprising storing image data corresponding to an immediately subsequent line of display elements, and comparing the received image data with the image data corresponding to the immediately subsequent line of display elements to determine the line time.

22. The method of claim 19, comprising determining the line time based at least in part on a polarity of a waveform applied to the common line.

23. The method of claim 19, wherein the line time includes a front porch duration, a back porch duration, and a write pulse duration, and wherein determining a line time includes determining at least one of the front porch duration and the back porch duration based at least in part on characteristics of segment line transitions produced when writing the image data to one or more common lines.

24. The method of claim 19, wherein the line time includes a front porch duration, a back porch duration, and a write pulse duration, and wherein determining a line time includes determining the write pulse duration based on a number of display elements along a common line that are to be transitioned from an un-actuated state to an actuated state when writing the received image data.

25. The method of claim 19, wherein determining the line time includes determining the line time for writing current image data to display elements along the one or more common lines of the array based on the write actuation state of the display elements along the one or more common lines.

26. The method of claim 19, wherein determining the line time includes determining the line time for writing current image data to display elements along the one or more common lines of the array based on characteristics of segment line transitions for writing the current image data to the display elements along the one or more common lines.

27. The method of claim 19, wherein determining the line time includes determining the line time for writing current image data to display elements along the one or more common lines of the array based on the write actuation state of the display elements along the one or more common lines and based on characteristics of segment line transitions for writing the current image data to the display elements along the one or more common lines.

28. An apparatus for driving a display including a plurality of common lines and a plurality of segment lines connected to an array of display elements, the apparatus comprising:
means for receiving image data, including image data for one or more common lines;
means for determining a line time for writing the image data to one or more common lines based at least in part on one or both of
a write actuation state of display elements along one or more common lines, and
characteristics of at least some segment line transitions in writing the image data to the display elements along the one or more common lines; and
means for writing the image data to display elements along one or more common lines with the determined line time.

29. The apparatus of claim 28, wherein the means for receiving image data includes a processor, the means for determining a line time includes a drive controller, and the means for writing the image data includes an array driver including a segment driver and a common driver.

30. The apparatus of claim 28, further comprising means for storing previously received image data, and wherein the means for determining a line time includes means for comparing the received image data with the previously received image data to determine the line time.

31. The apparatus of claim 28, further comprising means for storing image data corresponding to an immediately subsequent line of display elements, and means for comparing the received image data with the image data corresponding to the immediately subsequent line of display elements to determine the line time.

32. The apparatus of claim 28, wherein the line time includes a front porch duration, a back porch duration, and a write pulse duration, and wherein the means for determining a line time includes means for determining at least one of the front porch duration and the back porch duration based at least in part on characteristics of segment line transitions produced when writing the image data to one or more common lines.

33. The apparatus of claim 28, wherein the line time includes a front porch duration, a back porch duration, and a write pulse duration, and wherein the means for determining a line time includes means for determining the write pulse duration based on a number display elements along one or more common lines that are to be transitioned from an un-actuated state to an actuated state when writing the received image data.

34. A computer program product for processing data for a program configured to drive a display including a plurality of common lines and a plurality of segment lines connected to an array of display elements, the computer program product comprising:
a non-transitory computer-readable medium having stored thereon code for causing processing circuitry to:
receive image data including image data for one or more common lines;
determine a line time for the one or more common lines based at least in part on one or both of a write actuation state of display elements along one or more common lines and characteristics of at least some segment line transitions in writing the image data to the display elements along the one or more common lines; and
write the image data to display elements along one or more common lines with the determined line time.

35. The computer program product of claim 34, further comprising code for causing processing circuitry to store previously received image data, and code for causing processing circuitry to compare the received image data with the previously received image data to at least partially determine the line time.

36. The computer program product of claim 34, further comprising code for causing processing circuitry to store image data corresponding to an immediately subsequent line of display elements, and code for causing processing circuitry to compare the received image data with the image data corresponding to the immediately subsequent line of display elements to at least partially determine the line time.

37. The computer program product of claim 34, further comprising code for causing processing circuitry to at least partially determine the line time based on a polarity of a waveform applied to the common line.

38. The computer program product of claim 34, wherein the line time includes a front porch duration, a back porch duration, and a write pulse duration, the computer program product further comprising code for causing processing circuitry to determine at least one of the front porch duration and the back porch duration based at least in part on characteristics of at least some segment line transitions produced when writing the image data to one or more common lines.

39. The computer program product of claim 34, wherein the line time includes a front porch duration, a back porch duration, and a write pulse duration, the computer program product further comprising code for causing processing circuitry to determine the write pulse duration based at least in part on a number display elements along a common line that are to be transitioned from an un-actuated state to an actuated state when writing the received image data.
